(19) United States
(12) Patent Application Publication
(10) Pub. No.: US 2006/0106633 A1
(43) Pub. Date: May 18, 2006

(54) Real-time online commerce system

(76) Inventors: Kenneth Quintana, Tampa, FL (US); Alton Cutts, Allentown, PA (US)

Correspondence Address: KC Quintana, 2802 Northpoint Lane, Tampa, FL, 33611, US

(21) Appl. No.: 11/009,851

(22) Filed: Nov. 18, 2004

(51) Int. Cl. G06Q 99/00

(52) U.S. Cl. 705/1

(57) ABSTRACT

A real-tine online commerce system is disclosed. Such a system provides protection and security for the middleman and efficiency for the customer while keeping the ultimate manufacturer invisible and anonymous.

### BACKGROUND OF THE INVENTION

The present invention relates generally to electronic commerce systems, and specifically to providing real-time interface between an end use consumer and a production vendor through the Internet site of a dealer or sub dealer.

When a consumer is ordering custom printing or any similar product of unique specification or content, the necessity of communicating through a representative, dealer, or sub dealer is cumbersome and often entails delays. More direct communication with the source often leads to disclosure of confidential markup and profit structures on the part of the middlemen.

Further such direct communication provides opportunity to circumvent the middlemen thus losing the middleman an order or a customer.

Presently, Internet based sales systems of custom goods are either cumbersome or lacking in the protection of the investment, efforts, and interests of the middlemen. While there are perceived advantages, an inherent disadvantage to these systems is the necessity to choose between security and efficiency. While perhaps suitable for small one-time purchases, dealer understandably experience anxiety in trusting their customer lists to disclosure and their proprietary information to customers.

What is needed is a virtual commerce system that seamlessly allows all custom production source interface activities, including specifications, “proofing”, acknowledgment, and payment, to occur and appear as if the dealer were the producer of the custom product and where the ultimate manufacturer remains invisible and efficiency is inherent.

### SUMMARY OF THE INVENTION

The current invention comprises a unique software program to efficiently facilitate, over the Internet, the chain of commercial transaction steps from consumer, to representative, to sub Dealer, to dealer, to manufacturer, at each step protecting proprietary information. The software is installed on a third party server and is accessed and utilized at whatever level the user is authorized. Middlemen are able to appear on their individual websites as if they are the manufacturer, yet consumers are able to communicate with the factory as if they were the middlemen.

### DETAILS OF THE INVENTION

According to the invention, a software based system, residing on one or more servers is provided. Said system facilitates the efficacy of Internet marketing, order entry, production, and delivery of custom manufactured goods. The software provides for manufacturer-specific resource databases as to product specifications, pricing, and related categories. In General, while the current invention can simultaneously accommodate unlimited manufacturers producing all manner of goods, for illustration purposes, the following narrative contemplates only one manufacturer, specifically a printing plant.

Unlimited middlemen (representatives, dealers, and sub dealers) are provided for. Each authorized middleman can use a website of their own design or retrieve a product specific website format from the subject software server. They can retrieve any or all of the databases from the server for inclusion and presentation on their individual websites. The middleman has the option of marking up or discounting all pricing data. To the consumer the middleman appears to be the manufacturer. Customer interfaces as to order entry and order specifications filter seamlessly through the middleman website to the manufacturer. Manufacturer acknowledgments filter seamlessly to the consumer through the middleman website. Payments are also handled seamlessly through the middleman website to the manufacturer.

The system is structured to provide middlemen maximum latitude and autonomy to build their presentation and function as independent business entities, simultaneously providing the manufacturer with maximum efficiency in order entry and processing of custom orders.

A middleman's website menu presents a plurality of product options and services from which the consumer can make a selection. The website is responsive to the consumers' input indicating a particular product from a menu, the system provides product specification options, retrieved from the product database through via the Internet. Upon a purchase selection, including custom specifications, prompts are made for consumer specific information, such as a name and an address. The client can then enter purchase request to be transmitted to the manufacturer computer over the Internet.

The manufacturer is able to analyze the purchase specifications and respond with an acknowledgement and specifications as to form and format of the material to be printed, deadlines for the submission of consumer input, and a commitment for delivery.

Numerous benefits are achieved by way of the present invention over conventional techniques. These and other benefits are described throughout the present specification. A further understanding of the nature and advantages of the invention herein may be realized by reference to the remaining portions of the specification.

What is claimed is:

1. A system for providing real-time dealer and sub-dealer network interface between a vendor and its ultimate consumers in a wireless network, and said network environment comprising:
a plurality of dealer and sub-dealer world wide web home pages presenting product and vendor offerings and options;
said dealer and sub-dealer world wide web home pages being operatively disposed to present to a consumer a plurality of product options and services from which said consumer can make a selection and thereupon, responsive to consumer input indicating a particular product category from a menu, providing product information, retrieved from said product database, and thereupon to receive from said consumer a selection and to prompt said consumer for consumer specific and custom manufacture specification information, and thereupon to cause a purchase request to be transmitted to said vendor computer over said public packet communications network via the real-time dealer and sub-dealer interface;
said dealer and sub-dealers being autonomous in the design and content of their respective world wide web home pages;
said vendor being operatively disposed to present exclusively to dealer product cost and recommended retail data;
said dealer being autonomous in the determination of its profit margins and product pricing exclusively to its sub-dealers along with recommended retail data;
said sub-dealers being autonomous in the determination of their profit margins and retail product pricing to their consumers;
a plurality of wireless consumer terminals in communication with said wireless dealer and sub-dealer network interface and the vendor of the moment, to transmit said real-time notification of purchaser requirements;
at least one vendor computer, said vendor computer having at least one of a plurality of databases, including a product database having information about a plurality of products, and a dealer database, having information about a plurality of dealers, each with a sub-dealer database, having information about a plurality of sub-dealers, each with;
a plurality of consumer computers, said consumer computers and said vendor computer being interconnected by said public packet communications network via the real-time dealer and sub-dealer interface;
said vendor computer being operatively disposed to analyze said purchase request to determine the product availability and/or manufacture proximity information of said consumer purchase request;
said vendor computer being operatively disposed to cause information pertaining to said dealer and sub-dealer to be recorded in said dealer and sub-dealer database;
said vendor computer being operatively disposed to cause a confirmation message to be seat over said public wireless network via the dealer and sub-dealer interface, for display to said consumer, said confirmation message indicating that said selected vendor has agreed to enter into a commercial transaction.

2. The system of claim 1 wherein said vendor computer is further operative to provide transmitting said purchase requests in order of manufacturer priority and scheduling.

3. The system of claim 1 wherein said vendor computer is further operative to screen for compliance to specified criteria.

4. The system of claim 1 wherein said vendor computer is further operative to provide to said plurality of dealers and sub-dealers both periodic and on demand reports, including statistical analysis, reflecting purchase requests.

5. The system of claim 1 wherein said vendor computer is further operative to secure and authorize access of a dealer to proprietary cost, quotation, and recommended retail data.

6. The system of claim 1 wherein said dealer computer is further operative to secure and authorize access of its sub-dealers to proprietary dealer-determined cost, quotation, and recommended retail data.

7. The system of claim 1 wherein said product comprises printing.

8. The system of claim 7 wherein said product information further comprises paper or substrate, size, quantity, graphic input, miscellaneous specifications, and a description of said printing.

9. A method for providing real-time transmission of purchaser requirements in a wireless network environment, said wireless network environment comprising:
at least one vendor computer, said vendor computer having at least one of a plurality of databases, including a product database having information about a plurality of products, and a dealer database, having information about a plurality of dealers and a sub-dealer database, having information about a plurality of sub-dealers, and a consumer database, having information about a plurality of consumers;
at least one dealer or sub-dealer computer, said dealer or sub-dealer computer having an interface portal into said vendor computer product database;
a plurality of consumer computers, said consumer computers and said vendor computer being interconnected by said public wireless communications network via the dealer and sub-dealer interface, said method comprising the steps:
presenting to a consumer at one of said plurality of consumer computers a plurality of product options and services from which said consumer can make a selection, and thereupon;
providing product/production information, retrieved from said product database, responsive to consumer input indicating a particular product from a menu, and thereupon;
receiving from said consumer a selection and to prompt said consumer for consumer specific information, and thereupon;
causing a purchase request to be transmitted to said vendor computer over said communications network via the dealer and sub-dealer interface, and thereupon; causing information pertaining to said consumer to be recorded in said customer database,
causing a confirmation message to be sent over said wireless communications network via the dealer and sub-dealer interface for display to said consumer in order to enter into a commercial transaction.

10. The method of claim 9 further comprising:
providing a questionnaire reflecting consumers' comments about products and services offered.

11. The method of claim 9 further comprising:
providing to said vendor a report reflecting both periodic and on demand reports, including statistical analysis, reflecting transaction data.

12. The method of claim 9 further comprising:
providing to said plurality of dealers and sub-dealers both periodic and on demand reports, including statistical analysis, reflecting transaction data.

13. The method of claim 9 further comprising:
The method of claim 9 wherein said product comprises printing.

14. The method of claim 13 wherein said product information further comprises paper or substrate, size, quantity, graphic input, miscellaneous specifications, and a description of said printing.

15. A computer program product for providing real-time transmission of purchaser requirements in a heterogeneous network environment, said heterogeneous network environment having a wireless network, said heterogeneous network environment comprising:
a plurality of wireless terminals in communication with said wireless network to receive said real-time notification of purchaser requirements;
at least one vendor computer, said vendor computer having at least one of a plurality of databases, including a product database having information about a plurality of products, a dealer database having information about a plurality of dealers, a sub-dealer database having information about a plurality of sub-dealers, and a customer database, having information about a plurality of customers;
at least one vendor computer, said vendor computer interacting with consumers via one of a plurality of said dealers and sub-dealers via the wireless dealer and sub-dealer network interface a plurality of consumer computers, said consumer computers and said vendor computer being interconnected via said wireless dealer and sub-dealer network over said public wireless communications network, said computer program product comprising instructions for: presenting to a consumer a plurality of product options and services from which said consumer can make a selection and thereupon, responsive to consumer input indicating a particular product from a menu, providing product information retrieved from said product database, and thereupon to receive from said consumer a selection and to prompt said consumer for consumer specific information, and thereupon to cause a purchase request to be transmitted to said vendor computer via said wireless dealer and sub-dealer network over said wireless communications network;
said vendor computer being operatively disposed to analyze said purchase request to determine the product availability and/or manufacture proximity information of said consumer purchase request; said vendor computer being operatively disposed to cause information pertaining to said dealer and sub-dealer to be recorded in said dealer and sub-dealer database; said vendor computer being operatively disposed to cause a confirmation message to be seat over said public wireless network via the dealer and sub-dealer interface, for display to said consumer, said confirmation message indicating that said selected vendor has agreed to enter into a commercial transaction, and a computer readable storage medium for holding said instructions.

16. The computer program product of claim 15 further comprising instructions and options to a plurality of dealers and sub-dealers in the creation and individual administration of dealer and sub-dealer World Wide Web home pages presenting product and vendor offerings and options comprising;
said dealer and sub-dealer world wide web home pages being operatively disposed to present to a consumer a plurality of product options and services from which said consumer can make a selection and thereupon, responsive to consumer input indicating a particular product category from a menu, providing product information, retrieved from said product database, and thereupon to receive from said consumer a selection and to prompt said consumer for consumer-specific and custom manufacture specification information, and thereupon to cause a purchase request to be transmitted to said vendor computer over said wireless communications network via the real-time dealer and sub-dealer interface;
said dealer and sub-dealers being autonomous in the design and content of their respective world wide web home pages;
said vendor being operatively disposed to present exclusively to dealer product cost and recommended retail data;
said dealer being autonomous in the determination of its profit margins and product pricing exclusively to its sub-dealers along with recommended retail data;
said sub-dealers being autonomous in the determination of their profit margins and retail product pricing to their consumers;

17. The computer program product of claim 15 wherein said product comprises printing.

18. The computer program product of claim 15 wherein said product information further comprises paper or substrate, size, quantity, graphic input, miscellaneous specifications, and a description of said printing.

19. The computer program product of claim 15 further comprising instructions for providing to said plurality of vendors, vendor-specific reports reflecting a number of purchase requests forwarded to each of said vendors during a selectable time period.

20. The computer program product of claim 15 further comprising instructions for providing a questionnaire reflecting consumers' comments about products and services offered.
